(19) United States
(12) Patent Application Publication
(10) Pub. No.: US 2007/0272522 A1
(43) Pub. Date: Nov. 29, 2007

(54) Conveyor belt driver chain

(76) Inventor: Yee Tsun Kuo, Houston, TX (US)

Correspondence Address: Richard L. Moseley, P.O. Box 630708, Houston, TX, 77263, US

(21) Appl. No.: 11/441,424

(22) Filed: May 24, 2006

(51) Int. Cl. B65G 15/30

(52) U.S. Cl. 198/846; 198/849

(57) ABSTRACT

A link for a chain drive is provided comprising an elongate figure eight shaped body having a pair of axially aligned oblong axle apertures. The link is connected by axles at each end to other links having an elongate figure shaped bodies but having axially aligned round apertures. In the alternative each link may have one round aperture and one oblong aperture and the chain is connected such that the oblong apertures are aligned and connected to round apertures.

### BACKGROUND OF THE INVENTION

1. Field of the Invention

The present invention relates to conveyor belts used in the manufacture of extruded aluminum articles. More particularly the invention relates to a chain driven conveyor wherein the chain is attached to the underside of a conveyor belt. More particularly the invention relates to a chain link useful in conveyor chains that may expand or contract as it passes around a drive sprocket which prevents stretching of the belt and prevents binding which saves energy and operating costs.

2. Related Information

Conventional conveyor belts used in extruded aluminum production consists of a number of successive circular conveyor belts. In the past the conveyor belts were designed to effect conveyance by frictional tension between a felt belt and roller. Such belts often stretch under excessive load. Idle running and slippage are common occurrences due to sole reliance on frictional tension for conveyance. As a result the weight is unevenly distributed on other conveyor belts, worsening the performance of the belts and shortening the service life of the belts. In addition, the extruded aluminum products cannot be arranged neatly which adds to the inconvenience of the operation.

To overcome some of the limitations a sprocket and chain has been added to the underside of the felt belt. When the conveyor belt is not overloaded conveyance is effected by the frictional tension between the belt and the rollers. When the conveyor is overloaded by extruded aluminum product, conveyance is effected by engagement of the chain with the sprockets which prevents stretching of the belt, remarkably prolonging the service life of the belt and raising work efficiency.

The chains are typical of those in the art and include an axle mated round hole in an inner link which joins a round hole in the outer link. This type of chain has a drawback. As the chain goes around the round sprocket in a circular movement, the movement is not smooth due to the difference between the inside and outside diameter of the links. This lack of smoothness increases energy consumption and can stretch the belt at this point.

### SUMMARY OF THE INVENTION

Briefly the present invention comprises a link which replaces the round axle hole with an oblong hole. The oblong hole allows the axle to slide along the length of the link to compensate for the difference in inner and outer diameter as the link passes around the sprocket. In a chain, a link having an oblong hole is mated with a link having a round hole, i.e., if the inner links have oblong holes the outer links have round holes and if the outer links have oblong holes the inner links have round holes. Alternatively each link can have an oblong hole and a round hole, and when assembled the oblong holes in one link are mated with round holes in the opposite link. A chain is thus formed.

The advantage of the present chain over the existing chain is that the chain axle may be displaced in the oblong in the case of a turning motion, circular or clockwise-counterclockwise conversion of rotation and thus the difference between the inside diameter and outside diameter is eliminated. This eliminates the resistance to motion and ensures smooth movement of the chain and reduces power requirements. In addition the service life of the chain is remarkably prolonged and the effort and expenses for maintenance are reduced.

### BRIEF DESCRIPTION OF THE DRAWINGS

FIG. 1 is a side elevational view of several links of the present convention assembled together along with a portion of the felt conveyor belt.

FIG. 2 is a top view of the embodiment shown in FIG. 1.

FIG. 3 is an end view of the embodiment shown in FIG. 2.

FIG. 4 is a side elevational view of a link having an oblong axle hole.

FIG. 5 is an end view of an alternate embodiment.

FIG. 6 is an end on view of the link of FIG. 4.

FIG. 7 is a side elevational view of an alternate embodiment of the link of the present invention.

FIG. 8 is a side elevational view of a link having round apertures.

### DETAILED DESCRIPTION OF THE PREFERRED EMBODIMENT

For a detailed description of the preferred embodiment the reader is directed to accompany FIGURE's in which like components are given like reference numerals. Referring first to FIG. 4 a link 8 useful in the present invention is shown to have an elongate figure eight shaped body 12 having to axially aligned oblong axle apertures 6 located thereon. Each link 8 having oblong apertures 6 is mated with a link 14 having circular holes.

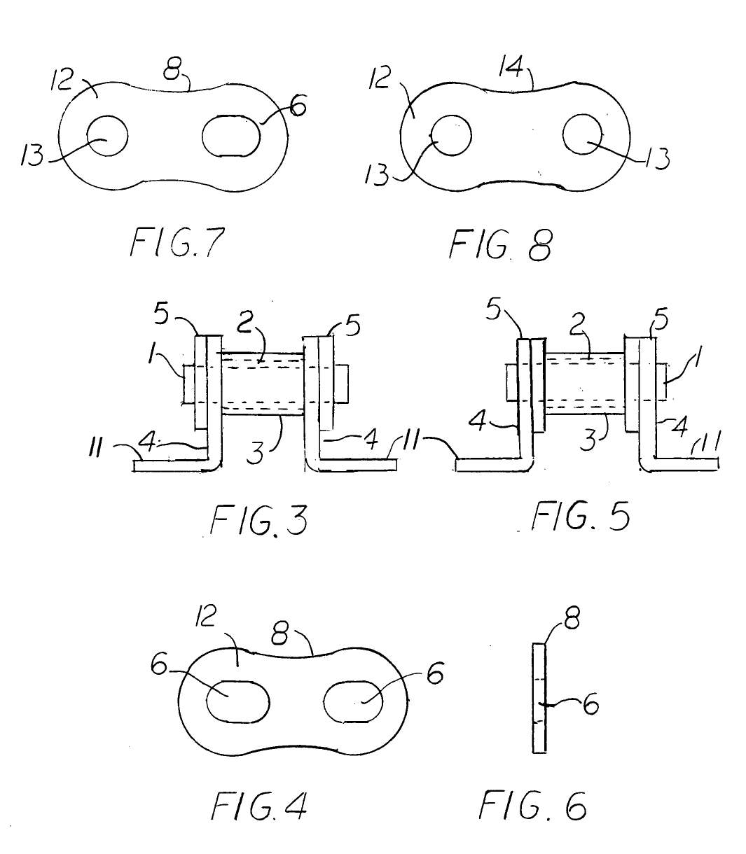

Referring now to FIGS. 3 and 5 a complete link is shown. A pair of outer links 5 are secured to a pair of inner links 4 by an axle 1 encased in a bushing 2. The pairs of outer links 5 and inner links 4 are spaced apart by a sleeve 3. A flange 11 is provided to secure the link to a felt conveyor belt (not shown). In FIG. 3 the flange is located on the inner link. In FIG. 5 the flange 11 is secured to the outer link.

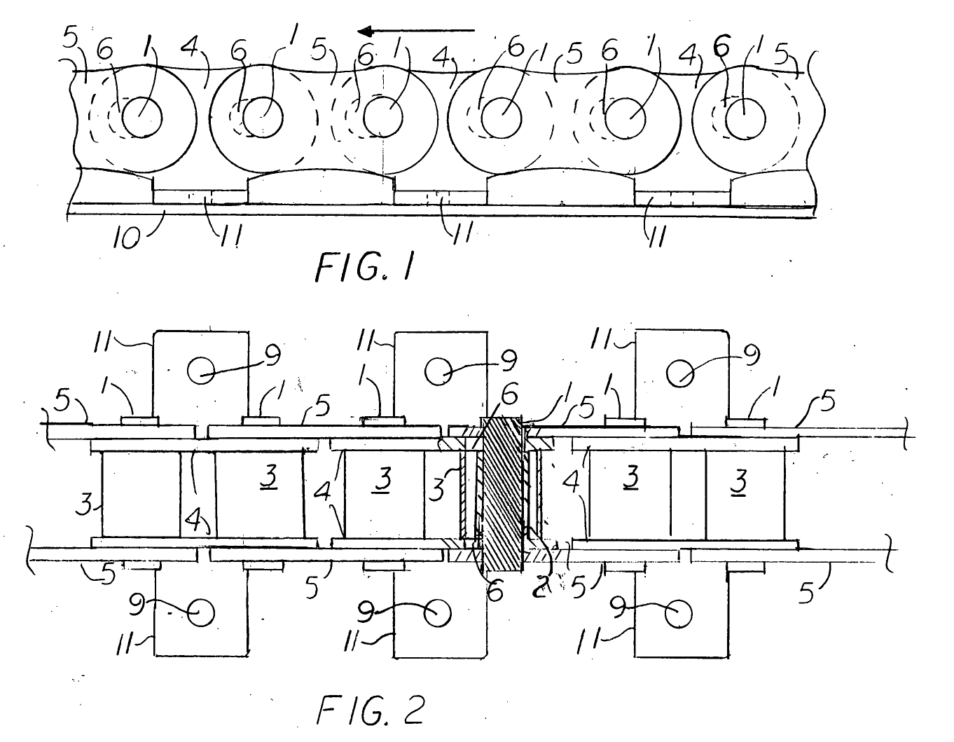

Referring now to FIGS. 1 and 2 a portion of the chain mounted on a felt belt 10 is shown with the direction of rotation shown by the arrow above. Links having the oblong apertures 6 are mounted as the inner links 4 while the outer links 5 have round apertures. The axle is shown at 1 and the flange at 11. In FIG. 2 a portion of one link is shown in partial cross section to reveal the axle 1 and bushing 2 inside the sleeve 3. The apertures 9 are for receiving the connectors for connecting the chain to the felt belt. As in FIG. 3 the flanges 11 are located on the inner links.

it should be appreciated that the oblong holes 6 and/or the flanges 11 could be located on the outer links 5 instead of the inner links 4. Alternatively each link could have one oblong hole 6 and one round hole 13 as depicted in FIG. 7 with the oblong holes 6 mated with the round holes 13 and the axle placed there through.

The foregoing description of the invention has been directed to a particular preferred embodiment of the present invention for the purposes of explanation and illustration. It will be apparent to those skilled in the art that many modifications and changes in the apparatus may be made without departing from the scope and spirit of the invention. It is therefore intended that the following claims cover all equivalent modifications and variations as fall within the scope of the invention as defined by the claims.

The invention claimed is:

1. A link for a chain drive comprising an elongate figure eight shaped body having a pair of axially aligned oblong axle apertures.

2. A sprocket chain for use with a conveyor comprising:
(a) a plurality of first links, each of said first links comprising a first pair of elongate figure eight shaped bodies, each of said first pair of elongate figure shaped bodies having a pair of axially aligned oblong axle apertures; and
(b) a plurality of second links, each of said second links comprising a second pair of elongate figure eight shaped, each of said second pair of elongate figure shaped bodied having a pair of axially aligned circular apertures, one each of said plurality of second links being connected to two each of said first plurality of first links such that one each of said pair of circular apertures is aligned with an oblong aperture on one each of said plurality of first links.

3. A conveyor belt for moving extruded aluminum products comprising:
(a) a flexible continuous belt;
(b) a chain connected to the underside of said belt, said belt comprising;
(1) a plurality of first links, each comprising an elongate figure eight shaped body and having a pair of axially aligned oblong axle apertures;
(2) a plurality of second links, each comprising an elongate figure eight shaped and having a pair of axially aligned circular apertures, one each of said plurality of second links being connected to two each of said first plurality of first links such that one each of said pair of circular apertures is aligned with an oblong aperture on one each of said plurality of first links; and
(3) a plurality of flanges secured to alternating links to attach said chain to said flexible belt; and
(c) a sprocket drive engaging said chain.
